(19) United States
(12) Patent Application Publication
(10) Pub. No.: US 2011/0273004 A1
(43) Pub. Date: Nov. 10, 2011

(54) BRAKE DEVICE ARRANGEMENT AND AUXILIARY DEVICE ARRANGEMENT OF A PNEUMATIC BRAKE SYSTEM OF A VEHICLE

(75) Inventors: Hartmut Mann, Bergkirchen (DE); Thomas Ernst, Emmering (DE); Jörg-Johannes Wach, Munchen (DE)

(73) Assignee: KNORR-BREMSE SYSTEME FUR SCHIENENFAHRZEUGE GMBH, Munchen (DE)

(21) Appl. No.: 13/120,216

(22) PCT Filed: Sep. 23, 2009
(86) PCT No.: PCT/EP2009/006862

§ 371 Date: Apr. 29, 2011

(30) Foreign Application Priority Data
Sep. 23, 2008 (DE) 102008048561.6

(51) Int. Cl. B60T 13/68; B60T 13/26; B60T 8/176; B60T 11/28

(52) U.S. Cl. 303/2; 303/13; 303/127

(57) ABSTRACT

A brake device arrangement and auxiliary device arrangement of a pneumatic brake system of a vehicle include a pneumatic control valve and other pneumatic components for carrying out braking functions or auxiliary braking functions of the braking system. In order to produce a modular construction, a brake control module, which is pre-mounted on a support for producing a braking pressure, is arranged adjacent to a filter module, for treating the air on the input side, and at least one auxiliary module for fulfilling the auxiliary braking functions.

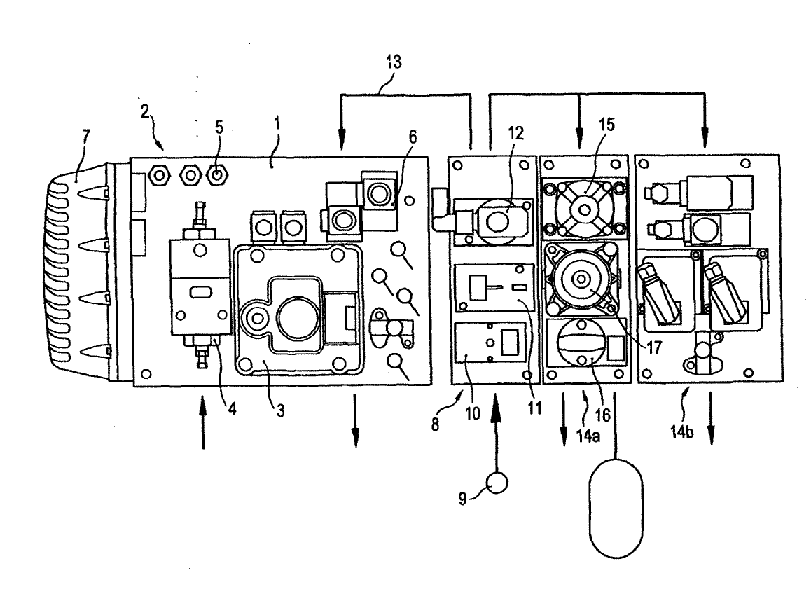

### RELATED APPLICATIONS

The present application claims the benefit of priority to International Patent Application No. PCT/EP2009/006862 filed 23 Sep. 2009, which further claims the benefit of International Patent Application No. 10 2008 048 561.6 filed 23 Sep. 2008, the contents of which are incorporated herein by reference in their entirety.

### FIELD OF INVENTION

Disclosed embodiments relate to a valve arrangement for controlling brake devices and auxiliary devices of a pneumatic brake system of a vehicle, the arrangement comprising pneumatic control valves and other pneumatic components for performing braking functions or auxiliary braking functions of the brake system.

### BACKGROUND

DE 1 905 561 U1 sets forth a pneumatic brake system for rail vehicles, in which a brake control valve is flange-mounted on a valve support. Compressed air is supplied to the brake control valve via ducts inside the valve support, which are fed from a main air line. The brake control valve is connected to an auxiliary brake reservoir and a brake cylinder via piping, which emerges from the valve support. From the main air line a further secondary line leads to a further valve support, flange-mounted on which are auxiliary devices of the brake system, in this a stopcock, a non-return valve and a non-return valve, which form a monitoring device for the filling of the auxiliary brake reservoir. The valve supports allow the brake devices and auxiliary devices mounted thereon to be easily fitted and removed, and if the valve support is advantageously fixed in a frame or to the vehicle good accessibility is afforded to the devices.

### SUMMARY

One disadvantage of this technical solution, however, is that conventional support plates are produced on boring and milling machines for individual devices, in order to form the internal compressed air ducts, so that the required connections can be provided. This leads to a costly individual fabrication of such valve supports, which are modified according to which brake devices and auxiliary devices the customer wishes to fit.

In order to minimize this production outlay, attempts have already been made to fit single valve support plates with brake devices or auxiliary devices so that those having the same flange pattern are interchangeable and can therefore perform different functional sequences on the same basic body. Since the geometric dimensions of the usual brake devices and auxiliary devices vary widely, however, considerably more basic bodies have to be provided in such a solution.

Therefore, disclosed embodiments create a largely modular construction representing many different variant configurations configured to existing design sizes of brake devices and auxiliary devices of pneumatic brake systems.

Disclosed embodiments extend primarily to the sphere of rail vehicle construction. Besides fulfilling its main function, braking, a compressed air-operated brake system of a rail vehicle also has to fulfill auxiliary functions, such as the provision of a parking brake, electromagnetic rail control, air suspension control, sanding control and the like. In terms of equipment, these auxiliary braking functions may be achieved not only by the braking control but also with the aid of peripheral equipment, such as control valves, pressure sensors, filter elements and the like.

Disclosed embodiments embrace the technical teaching that to produce a modular construction, a brake control module, preassembled on a support, for generating brake pressure, a filter module for inlet-side compressed air processing and at least one auxiliary module for fulfilling auxiliary braking functions are combined with one another by direct concatenation.

Such a modular arrangement may lie, in particular, in the fact that, through simple concatenation, auxiliary modules can be added to produce desired variants, so that auxiliary braking functions such as parking brake control, air suspension control, electromagnetic rail control, sanding control, pantograph control, wheel slide control and the like are easily feasible to suit customer requirements.

### BRIEF DESCRIPTION OF THE FIGURE

The FIGURE shows a front view of a schematic representation of a modular brake device and auxiliary device arrangement.

### DETAILED DESCRIPTION

In accordance with disclosed embodiment, the filter module may be situated between the brake control module and at least the one auxiliary module coupled thereto. Such an implementation ensures short line distances to the brake module and at the same time also to the auxiliary modules. This ensures that the compressed air is supplied in the optimum central area of the concatenated brake devices and auxiliary devices.

Optionally, if the brake device and auxiliary device arrangement described above is not controlled by a central electronic control unit of the vehicle, a separate electronic control module may be arranged at the end of the brake control module situated opposite the filter module. In this respect, the electronic control module may be situated on one face of the individual modules coupled through concatenation and, in as much, may be fully accessible from outside for connection purposes.

The support, on which the various brake devices and auxiliary devices are mounted, may be of lamellar design, to afford a stable fixing of the devices of various sizes. It is also feasible, however, to use rail-shaped supports if structural constraints of the devices make this seem advantageous.

The brake control module used in the context of the disclosed invention may comprise at least one control valve for the brake pressure, a pressure-limiting valve and various pressure sensors and solenoid valves, which are conventionally required in the context of brake control.

The filter module may be provided with a central inlet air connection of the R-line and may comprise a compressed air filter, a non-return valve and an outlet-side stopcock. The latter may serve for shutting off the admission flow to the brake control module, if control functions so dictate.

On the other hand, a permanent connection may exist to the auxiliary modules.

One example of an auxiliary module may be an air suspension control module, which may comprise a non-return valve, an overflow valve and an outlet-side stopcock, for example.

Further measures serving to enhance the disclosed embodiments are outlined in more detail below together with the description of the disclosed embodiments making reference to specific figures.

According to the figure, a brake control module 2, which here comprises a control valve 3, a pressure-limiting valve 4, pressure sensors 5 and a solenoid valve 6 as brake devices, is provided preassembled on a lamellar support 1. The brake control module 2 may be electrically controlled via an electronic control module 7 located directly on the end face of the former. A filter module 8, which undertakes the central supply of compressed air, may be arranged at the end of the brake control module 2 situated opposite the electronic control module 7. Adjacent to a compressed air connection 9, the filter module 8 may comprise a compressed air filter 10, followed by a non-return valve 11. A stopcock 12 may be provided on the outlet side of the filter module 8. The stopcock 12 may serve for selectively shutting off a control air line 13 towards the brake control module 2.

An air suspension control module may be provided as an auxiliary module 14a adjacent to the filter module 8. The auxiliary module 14a may comprise an overflow valve 15, a stopcock 16 and an outlet-side pressure-reducing valve 17. A further auxiliary module 14b may, in turn, be arranged adjacent to the auxiliary module 14a.

### List of Reference Numerals

1 support
2 brake control module
3 control valve
4 pressure-limiting valve
5 pressure sensor
6 solenoid valve
7 control module
8 filter module
9 compressed air source
10 compressed air filter
11 non-return valve
12 stopcock
13 control pressure
14 auxiliary module
15 overflow valve
16 stopcock
17 pressure-reducing valve

1. A brake device and auxiliary device arrangement of a pneumatic brake system of a vehicle, the arrangement comprising:
pneumatic control valves and other pneumatic components configured to perform braking functions or auxiliary braking functions of the brake system;
a brake control module, preassembled on a support, configured to generate brake pressure;
a filter module configured to provide inlet-side compressed air processing; and
at least one auxiliary module configured to fulfill auxiliary braking functions,
wherein the brake module, the filter module, and the at least one auxiliary module are combined with one another by direct concatenation.

2. The arrangement of claim 1, wherein the filter module is arranged between the brake control module and at least the one auxiliary module.

3. The arrangement of claim 1, further comprising an electronic control module is arranged at the end of the brake control module situated opposite the filter module.

4. The arrangement of claim 1, wherein the auxiliary module is configured, to fulfill at least one auxiliary braking function, which is selected from a group consisting of parking brake control, air suspension control, electromagnetic rail control, sanding control, pantograph control, and wheel slide control.

5. The arrangement of claim 1, wherein the brake control module comprises at least one control valve, a pressure-limiting valve and pressure sensors and a solenoid valve.

6. The arrangement of claim 1, wherein the filter module comprises at least one compressed air filter a non-return valve and an outlet-side stopcock.

7. The arrangement of claim 1, wherein the auxiliary module includes an air suspension control module, comprising an overflow valve, a stopcock and an outlet-side pressure-reducing valve.

8. The arrangement of claim 1, wherein the support is lamellar or rail-shaped.
